(19) United States
(12) Patent Application Publication
(10) Pub. No.: US 2005/0137009 A1
(43) Pub. Date: Jun. 23, 2005

(54) Electronic gaming device and method of initiating multiplayer game

(76) Inventor: Asko Lauri Antero Vetelainen, Jaali (FI)

Correspondence Address: CRAWFORD MAUNU PLLC, 1270 NORTHLAND DRIVE, SUITE 390, ST. PAUL, MN, 55120, US

(21) Appl. No.: 10/743,262

(22) Filed: Dec. 22, 2003

(51) Int. Cl. A63F 13/00

(52) U.S. Cl. 463/25

(57) ABSTRACT

A method of initiating a multiplayer game and an electronic gaming device are provided. The device comprises a communication unit providing bi-directional communication with at least one other gaming device, a display, a controlling unit providing an electronic calendar application, and a memory to store a gaming calendar item, the item comprising a time for a multiplayer gaming session and a game to be played. The device is configured to display an alarm on the display of the device when the gaming session is due, the alarm comprising a query whether or not to participate in the session, and to start the game in a multiplayer mode in the gaming device in response to a reply in the affirmative.

### FIELD

The invention relates to an electronic gaming device and to simplifying the initiation of multiplayer games between gaming devices.

### BACKGROUND

Electronic gaming devices have gained a wide spread popularity. Especially the use of small portable gaming devices has increased. Game functions have been added also to mobile terminals. Portable gaming devices offer entertainment and relaxation in various ways.

At first, the games offered by these devices were single player games, because this requires no communication abilities from the device. Lately the popularity of multiplayer games has greatly increased. In multiplayer games, several players play the same game with their own devices. Typically, the actions of all participants in the game can be seen in all devices. Multiplayer games are attractive to players because of more sophisticated game plots and unexpected actions in a game due to human spontaneity.

In addition to the communication abilities of the gaming devices, multiplayer games require some communication between the participating players before a multiplayer game can be initiated. The players have to agree on the game to be played and also when to play. In prior art this communication has been carried out either by spoken communication with a player within sight or by email messages, short messages or phone calls. After the players have agreed to play, each player has started the game application in multiplayer mode and the established contact using the game multiplayer options. These methods are cumbersome as they require separate communication means before the game can be started.

### BRIEF DESCRIPTIONS OF THE INVENTION

An object of the invention is to provide an improved solution for multiplayer gaming. According to an embodiment of the invention, there is provided a method of initiating a multiplayer game in an electronic gaming device, comprising: providing a gaming calendar item in the electronic gam ing device, the item comprising a time for a multiplayer gaming session and a game to be played, storing the gaming calendar item in a calendar application of the gaming device, displaying an alarm on a display of the device when the gaming session is due, the alarm comprising a query whether or not to participate in the session, receiving a reply to the query, starting the game in a multiplayer mode in the gaming device in response to a positive reply.

According to another embodiment of the invention, there is provided a method of initiating a multiplayer game in an electronic gaming device, comprising: receiving a gaming calendar item, the item comprising a time for a multiplayer gaming session and a game to be played, storing the gaming calendar item in a calendar application of the gaming device, displaying an alarm on a display of the device when the gaming session is due, the alarm comprising a query whether or not to participate in the session, receiving a reply to the query, starting the game in a multiplayer mode in the gaming device in response to a positive reply.

According to another embodiment of the invention, there is provided an electronic gaming device comprising a communication unit providing bidirectional communication with at least one other gaming device, a display, a controlling unit connected to the display and the communication unit, providing an electronic calendar application, a memory connected to the controlling unit to store a gaming calendar item, the item comprising a time for a multiplayer gaming session and a game to be played, the controlling unit being configured to display an alarm on the display of the device when the gaming session is due, the alarm comprising a query whether or not to participate in the session, start the game in a multiplayer mode in the gaming device in response to a positive reply.

According to yet another embodiment of the invention, there is provided an electronic gaming device comprising a communication unit providing bi-directional communication with at least one other gaming device, a display, a controlling unit connected to the display and the communication unit, providing an electronic calendar application, the controlling unit and the communication unit being configured to receive a gaming calendar item, the item comprising a time for a multiplayer gaming session and a game to be played, the device further comprising a memory connected to the controlling unit to store the gaming calendar item, the controlling unit being configured to display an alarm on the display of the device when the gaming session is due, the alarm comprising a query whether or not to participate in the session, start the game in a multiplayer mode in the gaming device in response to a positive reply.

According to yet another embodiment of the invention, there is provided a computer program product encoding a computer program of instructions for executing a computer process for initiating a multiplayer game in an electronic gaming device, the process comprising: providing a gaming calendar item in an electronic gaming device, the item comprising a time for a multiplayer gaming session and the game to be played, storing the gaming calendar item in a memory of the electronic gaming device, displaying an alarm on a display of the device when the gaming session is due, the alarm comprising a query whether or not to participate in the session, receiving a reply to the query, starting the game in a multiplayer mode in the gaming device in response to a positive reply.

According to yet another embodiment of the invention, there is provided a computer program distribution medium readable by a computer and encoding a computer program of instructions for executing a computer process for initiating a multiplayer game in an electronic gaming device, the process comprising: providing a gaming calendar item in an electronic gaming device, the item comprising a time for a multiplayer gaming session and the game to be played, storing the gaming calendar item in a memory of the electronic gaming device, displaying an alarm on the display of the device when the gaming session is due, the alarm comprising a query whether or not to participate in the session, receiving a reply to the query, starting the game in a multiplayer mode in the gaming device in response to a positive reply.

The solution of the invention provides several advantages. The solution solves the difficulties related to initiating a multiplayer game. The establishment of a multiplayer game is more user friendly than in the prior art solutions. Furthermore, the solution enables users to keep track of agreed playing sessions.

### LIST OF DRAWINGS

In the following, the invention will be described in greater detail with reference to preferred embodiments and the accompanying drawings, in which

FIG. 1 illustrates an example of a network environment,

FIG. 2 illustrates an example of the structure of an electronic gaming device,

FIGS. 3A to 3C illustrate examples of a calendar application view,

FIGS. 4A and 4B illustrate further examples of a calendar application view, and

FIGS. 5 and 6 are flowcharts illustrating embodiments of the invention.

### DESCRIPTION OF EMBODIMENTS

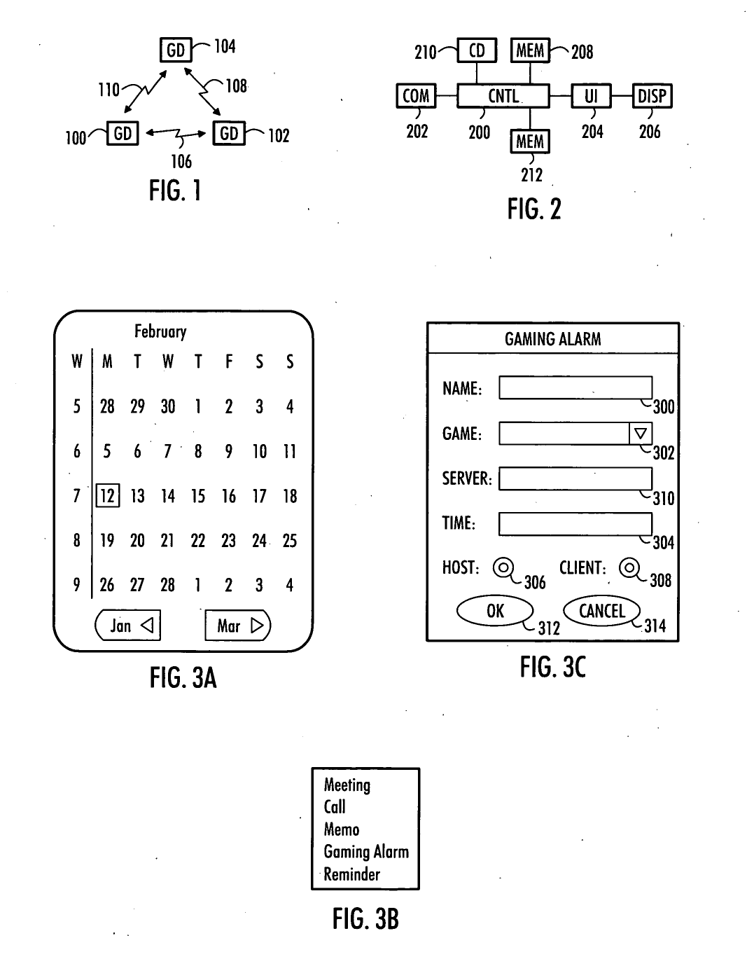

FIG. 1 illustrates an example of a network environment whereto embodiments of the invention may be applied. In FIG. 1 there are three gaming devices 100, 102, 104. The gaming devices are configured to communicate with each other using communication connections 106, 108, 110. The connections may be wireless connections, which can be realized in many ways. For example, the connections may be realized with short-range radio transmissions such as Bluetooth, or with infrared connections. A connection may also utilize the services of a cellular radio network. In such a case, the connection may be a GPRS (General Radio Packet System) connection, for example. The connections may also be realized with a wireline network. The distance between single devices may exceed the distance usually acceptable for vocal communication.

In an embodiment, the devices may have several connections open simultaneously. For example, the devices may be GPRS terminals having an ongoing phone call while a GPRS gaming session is on.

FIG. 2 illustrates an example of the structure of an electronic gaming device. The device comprises a controlling unit 200 controlling the operation of the device. The controlling unit may be realized with a processor with suitable software or with separate logic circuits, for example. The device further comprises a communication unit 202 providing a bi-directional communication with other gaming devices. The communication unit 202 may provide support also for other communication purposes. The gaming device may, for example, be a mobile terminal in a cellular network. The communication unit 202 may be a GPRS transceiver, a short-range radio transceiver (such as a Bluetooth transceiver, for example) or an infrared transceiver. The communication unit may also support communication via wire connections.

The device further comprises a user interface 204 connected to the controlling unit. The user interface may comprise a display 206. The user interface may also comprise a keyboard or an other input device. User input may also be realized with a touch sensitive display, for example.

The device further comprises a first memory 208 to store various data required by the operation of the device. The memory may store applications used in the device. The memory may store games supported by the device.

In an embodiment, the device comprises a removable memory reader 210, such as a card reader. Some games are delivered on readable cards, such as an MMC (Multimedia Card), for example. These cards may be installed into the card reader and the game application can thus be executed on the device.

In an embodiment, applications and games may be installed and removed from the device at the user's will. The applications and games may be loaded from a network and stored in the memory 208 or they may be executed from a card in the card reader 210. As the games, which are installed into the device, may vary, the memory 208 may comprise information about games currently supported by the device. The information may be in the form of a database, for example.

In an embodiment, the device comprises a second memory 212 to store information about contacts. The contact information may comprise names, addresses and other information on contacts. In an embodiment, the contact information is stored as a database in the memory 212. In an embodiment, the memories 208 and 212 of the device may be implemented with one or more memory units or memory chips.

In an embodiment, the controlling unit provides an electronic calendar application. The calendar may be used to keep track of reminders, meetings, and birthdays, for example. The calendar items can be stored in the memory 208 or 212. The memory may store a gaming calendar item, which comprises a time for a multiplayer gaming session and the game to be played. The item may further comprise information about the server of the multiplayer game. In multiplayer games played on several devices, one of the participating devices may act as a server, which controls the game. In some games, the server may be an external computer, which is not used by any players. The calendar application is configured to display an alarm on the display of the device when the gaming session indicated in the gaming calendar item is due. The alarm may comprise a query whether or not to participate in the session. If the user of the device replies in the affirmative to the query, the controlling unit is configured to start the game in a multiplayer mode in the gaming device.

In an embodiment, a user of an electronic gaming device may open the calendar application and create a gaming calendar item. This is illustrated in FIGS. 3A to 3C and in the flowchart of FIG. 5. FIG. 3A illustrates a typical calendar view displayed on the display of the gaming device. Assuming that the user wishes to set a gaming calendar item for February 12^{th}, the user may select the desired day in step 500. In step 502, the calendar application shows the user a menu illustrated in FIG. 3B. The menu comprises different calendar items which may be set. In this example the user selects a “Gaming alarm” item.

The calendar application receives the selected “Gaming alarm” in step 504. Next, in step 506, the user is shown a view where properties of the gaming calendar item can be filled in. FIG. 3C illustrates an example of the view. In practice, the view can be realized in many different ways, depending on the display capabilities of the electronic gaming device. The item comprises a name 300, which illustrates the gaming event. The name can be used as a title when the item is shown in the calendar application. The user may select the game to be played from a drop down list 302. In an embodiment, the list comprises the games the device currently supports. The list may consist of games which support multiplaying or, alternatively, all games can be presented in the list. The user is able to type the time of day 304 the gaming session is planned to take place. Using buttons 306, 308, the user is also able to define whether the user's device is a host or a client in the upcoming gaming session. If the user selects the “Client” button, a server-field 310 may be filled in. The field comprises the address of the host or the server of the game. If the user selects the “Host” button, the calendar application is configured to fill in the server-field 310 with the device's own address. The view further comprises buttons 312, 314 with which the user may accept the information or cancel the operation. In step 508, the calendar application receives the user's selection of the accepting button 308. In step 510, the calendar application stores the gaming item in the memory 208 or 212.

The address of the server may be an IP (internet Protocol) address in a numeric or DNS (Domain Name Server) form, a telephone number or any other type of address with which a server may be reached.

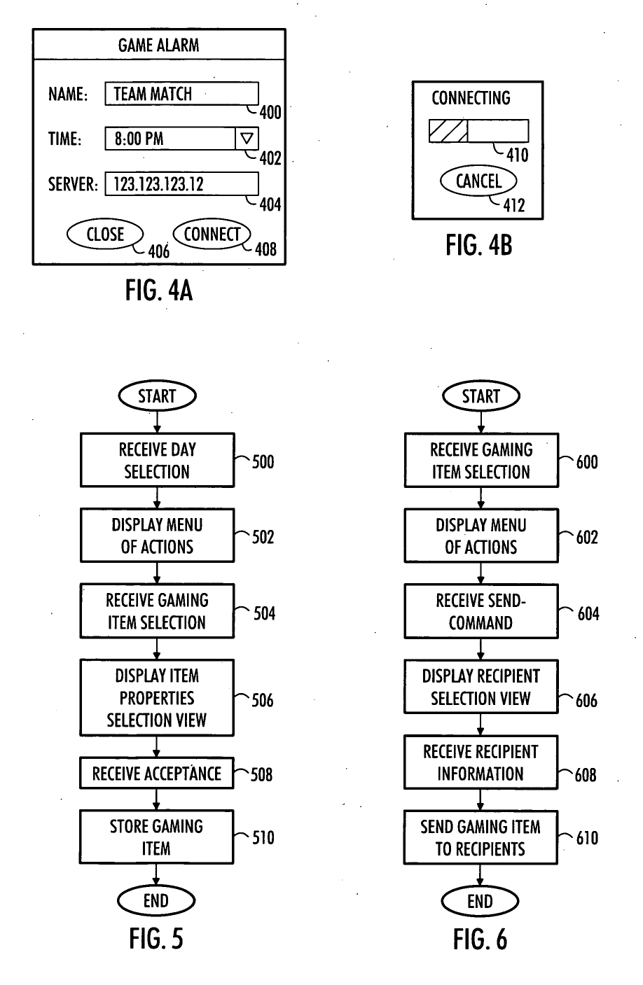

The calendar application supports the creation and storing of gaming items. In an embodiment, when the gaming session indicated by the gaming calendar item is due, the calendar application is configured to alert the user in a predetermined way. FIG. 4A illustrates an example of the alert, which is displayed on the display of the gaming device. In practice, the alert can be realized in many different ways, depending on the display capabilities of the electronic gaming device. In this example, the alert comprises the name 400 of the item, the time of the game 402, and the address 404 of the server of the game. The alert may be cancelled by pressing the “Close” button 406, in which case the game is not started. By pressing the “Connect” button 408, the game is started in a multiplayer mode. The device is configured to check the server address of the gaming item. If the server address indicates another device, the gaming device tries to contact the server of the game. The user may be notified by this with a connect view, such as the view presented in FIG. 4B. The view may comprise a progress bar 410 and a “Cancel” button 412, with which the user may cancel the operation.

If the server address is the same as the device's own address, no contact to another device is required at this point. The calendar application starts the game in a multiplayer mode and the game waits for the other participants to join the game.

In an embodiment, the calendar application supports the sending of a gaming calendar item to at least one other gaming device. This is illustrated in the flowchart of FIG. 6. When the user selects the gaming calendar item in the calendar application in step 600, the calendar application is configured to present a menu to the user in step 602. The menu comprises different operations, which can be performed on the item, such as edit, delete and move. The menu also comprises a send option. After receiving the selected send option in step 604, the calendar application is configured to allow the user to select the recipients of the gaming item message in step 606. This may be realized using a drop down list or a contact card application, for example. The recipients may be individual users or a group of users. In step 608, the calendar application receives the information on the recipients' addresses, and sends the item in step 610. The selection of recipients and the actual sending of the item may be performed by a mail or a communication application of the device on behalf of the calendar application. The item may be sent using various communication methods. For example, the communication may be realized with short-range radio transmissions, such as Bluetooth, or with infrared connections. The communication may also be realized with the services of a cellular radio network as text or multimedia messages or with a wired connection.

In an embodiment, the electronic gaming device is configured to receive a gaming calendar item, the item comprising a time for a multiplayer gaming session and the game to be played. The user may view the calendar item and accept or reject the item. If the item is accepted, the device is configured to store the gaming calendar item in a calendar application of the gaming device. The calendar application is configured to display an alarm on the display of the device when the gaming session is due, the alarm comprising a query whether or not to participate in the session. The alarm is illustrated and described above in connection with FIG. 4A. After receiving a positive response to the query from the user, the device is configured to start the game in a multiplayer mode in the gaming device.

The user may edit the gaming calendar item. For example, if the server of the game to be played changes before the game is due, the user may make a corresponding change in the server field 304 of the calendar item.

In an embodiment, the solution is implemented as a computer program product encoding a computer program of instructions for executing a computer process for initiating a multiplayer game in an electronic gaming device. In an embodiment, the solution is implemented as a computer program distribution medium readable by a computer and encoding a computer program of instructions for executing a computer process for initiating a multiplayer game in an electronic gaming device. The distribution medium may be a type of the following types: a computer readable medium, a program storage medium, a record medium, a computer readable memory, a computer readable software distribution package, a computer readable signal, a computer readable telecommunications signal, a computer readable compressed software package.

The calendar application may be loaded into the electronic gaming device from a distribution medium readable by the device. The application may be loaded from a network or from a card, for example. The application may be stored in the memory 208 or 212 or it may be executed from a card in the card reader 210.

Even though the invention has been described above with reference to an example according to the accompanying drawings, it is clear that the invention is not restricted thereto but it can be modified in several ways within the scope of the appended claims.

1. A method of initiating a multiplayer game in an electronic gaming device, comprising:
providing a gaming calendar item in the electronic gaming device, the item comprising a time for a multiplayer gaming session and a game to be played,
storing the gaming calendar item in a calendar application of the gaming device,
displaying an alarm on a display of the device when the gaming session is due, the alarm comprising a query whether or not to participate in the session,
receiving a reply to the query,
starting the game in a multiplayer mode in the gaming device in response to a positive reply.

2. The method of claim 1, further comprising:
sending the gaming calendar item to at least one other gaming device.

3. The method of claim 1, wherein the gaming calendar item comprises information about a server of the multiplayer game.

4. A method of initiating a multiplayer game in an electronic gaming device, comprising:
receiving a gaming calendar item, the item comprising a time for a multiplayer gaming session and a game to be played,
storing the gaming calendar item in a calendar application of the gaming device,
displaying an alarm on a display of the device when the gaming session is due, the alarm comprising a query whether or not to participate in the session,
receiving a reply to the query,
starting the game in a multiplayer mode in the gaming device in response to a positive reply.

5. An electronic gaming device comprising
a communication unit providing bi-directional communication with at least one other gaming device,
a display,
a controlling unit connected to the display and the communication unit, providing an electronic calendar application,
a memory connected to the controlling unit to store a gaming calendar item, the item comprising a time for a multiplayer gaming session and a game to be played,
the controlling unit being configured to
display an alarm on the display of the device when the gaming session is due, the alarm comprising a query whether or not to participate in the session,
start the game in a multiplayer mode in the gaming device in response to a positive reply.

6. The electronic gaming device of claim 5, wherein the device is configured to send the gaming calendar item to at least one other gaming device.

7. The electronic gaming device of claim 5, wherein the gaming calendar item comprises information about the server of the multiplayer game, and the device is configured to connect to the server when the game is started.

8. An electronic gaming device comprising
a communication unit providing bi-directional communication with at least one other gaming device,
a display,
a controlling unit connected to the display and the communication unit, providing an electronic calendar application,
the controlling unit and the communication unit being configured to receive a gaming calendar item, the item comprising a time for a multiplayer gaming session and a game to be played,
the device further comprising a memory connected to the controlling unit to store the gaming calendar item,
the controlling unit being configured to
display an alarm on the display of the device when the gaming session is due, the alarm comprising a query whether or not to participate in the session,
start the game in a multiplayer mode in the gaming device in response to a positive reply.

9. A computer program product encoding a computer program of instructions for executing a computer process for initiating a multiplayer game in an electronic gaming device, the process comprising:
providing a gaming calendar item in an electronic gaming device, the item comprising a time for a multiplayer gaming session and the game to be played,
storing the gaming calendar item in a memory of the electronic gaming device,
displaying an alarm on a display of the device when the gaming session is due, the alarm comprising a query whether or not to participate in the session,
receiving a reply to the query,
starting the game in a multiplayer mode in the gaming device in response to a positive reply.

10. The product of claim 9, further comprising:
sending the gaming calendar item to at least one other gaming device.

11. A computer program distribution medium readable by a computer and encoding a computer program of instructions for executing a computer process for initiating a multiplayer game in an electronic gaming device, the process comprising:
providing a gaming calendar item in an electronic gaming device, the item comprising a time for a multiplayer gaming session and the game to be played,
storing the gaming calendar item in a memory of the electronic gaming device,
displaying an alarm on the display of the device when the gaming session is due, the alarm comprising a query whether or not to participate in the session,
receiving a reply to the query,
starting the game in a multiplayer mode in the gaming device in response to a positive reply.

12. The computer program distribution medium of claim 11, the distribution medium comprising a computer readable medium, a program storage medium, a record medium, a computer readable memory, a computer readable software distribution package, a computer readable signal, a computer readable telecommunications signal, and a computer readable compressed software package.
